(19) United States
(12) Patent Application Publication
(10) Pub. No.: US 2021/0295680 A1
(43) Pub. Date: Sep. 23, 2021

(54) CONTROL DEVICE, A NON-TRANSITORY STORAGE MEDIUM, AND SYSTEM

(71) Applicant: KABUSHIKI KAISHA TOKAI RIKA DENKI SEISAKUSHO, Aichi (JP)

(72) Inventors: Yosuke OHASHI, Aichi (JP); Yosuke HASEGAWA, Aichi (JP); Shingo MOCHIZUKI, Aichi (JP); Norihiro SHIMIZU, Aichi (JP)

(73) Assignee: KABUSHIKI KAISHA TOKAI RIKA DENKI SEISAKUSHO, Aichi (JP)

(21) Appl. No.: 17/164,001

(22) Filed: Feb. 1, 2021

(30) Foreign Application Priority Data
Mar. 19, 2020 (JP) 2020-049818

(51) Int. Cl. G08C 17/04

(52) U.S. Cl. CPC G08C 17/04; G08C 2201/93; G08C 2201/60

(57) ABSTRACT

To perform authentication and execute a function on the basis of clear intention of a user through single operation performed by the user.

There is provided a control device that is installed in a mobile object, the control device comprising: a near-field wireless communication section configured to perform near-field wireless communication with a portable device; and a control section configured to authenticate the portable device on a basis of authentication information that the near-field wireless communication section has acquired from the portable device through the near-field wireless communication, and configured to perform control on a basis of a result of the authentication, wherein the control section performs control in such a manner that a prescribed function related to a control target device installed in the same mobile object is executed in a case where the authentication is successful.

### CROSS REFERENCE TO RELATED APPLICATION(S)

This application is based upon and claims benefit of priority from Japanese Patent Application No. 2020-049818, filed on Mar. 19, 2020, the entire contents of which are incorporated herein by reference.

### BACKGROUND

The present invention relates to a control device, a non-transitory storage medium, and a system.

In recent years, technologies of performing authentication in accordance with a result of transmitting/receiving a signal between devices and performing some kind of control on the basis of a result of the authentication have been developed. For example, JP H11-208419A discloses a system that authenticates a portable device by transmitting/receiving a signal between an in-vehicle device and a portable device and opens a door lock in the case where the authentication is successful.

However, when using the system disclosed in JP H11-208419A, a user has to separately perform operation of expressing his/her intention to get in a vehicle after the portable device is successfully authenticated.

Accordingly, the present invention is made in view of the aforementioned issue, and an object of the present invention is to perform authentication and execute a function on the basis of clear intention of a user through single operation performed by the user.

### SUMMARY

To solve the above described problem, according to an aspect of the present invention, there is provided a control device that is installed in a mobile object, the control device comprising: a near-field wireless communication section configured to perform near-field wireless communication with a portable device; and a control section configured to authenticate the portable device on a basis of authentication information that the near-field wireless communication section has acquired from the portable device through the near-field wireless communication, and configured to perform control on a basis of a result of the authentication, wherein the control section performs control in such a manner that a prescribed function related to a control target device installed in the same mobile object is executed in a case where the authentication is successful.

To solve the above described problem, according to another aspect of the present invention, there is provided a non-transitory storage medium having a program stored therein, the program causing a computer to function as a control device that is installed in a mobile object, wherein control device executes a control function of authenticating a portable device on a basis of authentication information acquired from the portable device through near-field wireless communication, and performing control on a basis of a result of the authentication, and the control device performs control in such a manner that a prescribed function related to a control target device installed in the same mobile object is executed in a case where the authentication is successful.

To solve the above described problem, according to another aspect of the present invention, there is provided a system that includes a portable device and a control device installed in a mobile object, wherein the control device includes a near-field wireless communication section configured to perform near-field wireless communication with the portable device, and a control section configured to authenticate the portable device on a basis of authentication information that the near-field wireless communication section has acquired from the portable device through the near-field wireless communication, and configured to perform control on a basis of a result of the authentication, and the control section performs control in such a manner that a prescribed function related to a control target device installed in the same mobile object is executed in a case where the authentication is successful.

As described above, according to the present invention, it is possible to perform authentication and execute a function on the basis of clear intention of a user through single operation performed by the user.

### BRIEF DESCRIPTION OF THE DRAWINGS

FIG. 1 is a block diagram illustrating a configuration example of a system 1 according to an embodiment of the present invention.

FIG. 2 is a sequence diagram illustrating an example of a flow of operation of the system 1 according to the embodiment.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. Embodiment

### 1.1. System Configuration Example

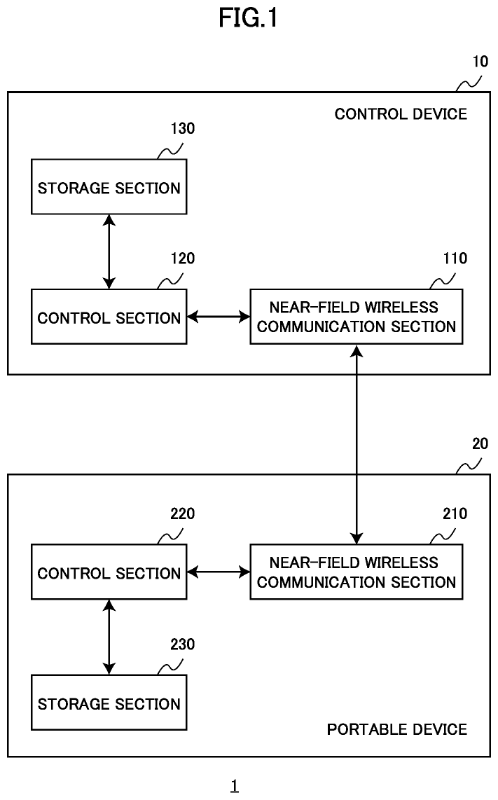

First, a configuration example of a system 1 according to an embodiment of the present invention will be described. FIG. 1 is a block diagram illustrating the configuration example of the system 1 according to the embodiment of the present invention. As illustrated in FIG. 1, the system 1 according to the present embodiment includes a control device 10 and a portable device 20.

(Control Device 10)

The control device 10 according to the present embodiment is a device that is installed in a mobile object such as a vehicle and that controls various kinds of control target devices installed in the same mobile object. As illustrated in FIG. 1, the control device 10 according to the present embodiment includes a near-field wireless communication section 110, a control section 120, and a storage section 130.

((Near-Field Wireless Communication Section 110))

The near-field wireless communication section 110 according to the present embodiment performs near-field wireless communication with the portable device 20 carried by a user. The near-field wireless communication section 110 according to the present embodiment may perform near-field wireless communication with the portable device 20, by using a communication standard that makes it possible to perform non-contact communication such as a communication standard with a maximum communication distance of approximately 10 cm. Examples of such a communication standard include Near-Field-Communication (NFC).

Through the near-field wireless communication in conformity with the above-described communication standard, the near-field wireless communication section 110 according to the present embodiment acquires authentication information from the adjacent portable device 20 within the communication distance. The authentication information is used by the control section 120 to authenticate the portable device 20.

The near-field wireless communication section 110 according to the present embodiment includes an antenna to perform the near-field wireless communication described above.

((Control Section 120))

The control section 120 according to the present embodiment controls the near-field wireless communication between the near-field wireless communication section 110 and the portable device 20. In addition, the control section 120 according to the present embodiment authenticates the portable device 20 on the basis of authentication information that the near-field wireless communication section 110 has acquired from the portable device 20. Examples of the authentication information include an identifier such as an ID of the portable device 20, key information that is shared in advance, a computation result using a hash function, and the like. The authentication information according to the present embodiment and an authentication mechanism using the authentication information may be designed in any ways depending on desired security and the like.

The control section 120 according to the present embodiment performs various kinds of control on the basis of a result of the authentication of the portable device 20. For example, the control section 120 according to the present embodiment performs control in such a manner that a prescribed function related to the control target device installed in the same mobile object is executed in the case where the authentication is successful (in other words, in the case where authenticity of the portable device 20 is confirmed).

By using the above-described configuration, it is possible to combine operation performed by the user to start the authentication and operation performed by the user to express intention to instruct to execute the prescribed function, into single operation. Therefore, the control device 10 according to the present embodiment makes it possible to perform the authentication and execute the prescribed function on the basis of the single operation with clear intention of the user to put the portable device 20 closer to an area within the communication distance of the near-field wireless communication section 110.

Examples of the control target device according to the present embodiment include a lock device installed in the mobile object, an opening and closing device that opens and closes a door of the mobile object, a power source device installed in the mobile object, and the like. The power source device includes an ignition power source and an accessory power source.

In addition, the control section 120 according to the present embodiment may control execution of the prescribed function related to the control target device on the basis of an execution state of a function of the control target device.

For example, the execution state may include a first state and a second state. In this case, the control section 120 performs control in such a manner that the execution state becomes the second state in the case where the execution state related to the control target device is the first state. On the other hand, the control section 120 performs control in such a manner that the execution state becomes the first state in the case where the execution state related to the control target device is the second state.

For example, in the case where the control target device is the lock device installed in the mobile object, the first state is assumed to a locked state, and the second state is assumed to be an unlocked state. Accordingly, after the portable device 20 is successfully authenticated, the control section 120 may perform control to open the lock device in the case where the lock device is closed. On the other hand, in the case where lock device is open, the control section 120 may perform control to close the lock device.

Alternatively, for example, in the case where the control target device is the opening and closing device that opens and closes the door of the mobile object, the first state is assumed to be a state where the door is closed, and the second state is assumed to be a state where the door is open. Accordingly, after the portable device 20 is successfully authenticated, the control section 230 may perform control to open the door in the case where the door of the mobile object is closed. On the other hand, in the case where the door is open, the control section 120 may perform control to close the door.

Alternatively, for example, in the case where the control target device is the power source device installed in the mobile object, the first state is assumed to be a state where the power source device is turned on, and the second state is assumed to be a state where the power source device is turned off. Accordingly, after the portable device 20 is successfully authenticated, the control section 120 may perform control to turn on the power source device in the case where the power source device installed in the mobile object is turned off. On the other hand, in the case where the power source device is turned on, the control section 120 may perform control to turn off the power source device.

As described above, the control section 120 according to the present embodiment makes it possible to perform control in such a manner that two different states related to execution of the function of the control target device are switched.

Note that, for example, the function of the control section 120 is implemented by a processor such as a CPU.

((Storage Section 130))

The storage section 130 according to the present embodiment stores various kinds of information to be used for operation of the control device 10. For example, the storage section 130 stores information to be used for checking efficacy of the above-described authentication information with regard to authentication performed by the control section 120 (such as the identifier of the portable device 20, key information, or hash function). In addition, the storage section 130 stores various kinds of programs to be used by the control section 120.

(Portable Device 20)

The portable device 20 according to the present embodiment is a device carried by the user who is a legitimate user (such as owner or renter) of the mobile object provided with the control device 10. Examples of the portable device 20 according to the present embodiment include an IC card, a smartphone, a wearable device, and the like. As illustrated in FIG. 1, the portable device 20 according to the present embodiment includes a near-field wireless communication section 210, a control section 220, and a storage section 230.

((Near-Field Wireless Communication Section 210))

The near-field wireless communication section 210 according to the present embodiment performs near-field wireless communication with the control device 10. For example, the near-field wireless communication section 210 according to the present embodiment transmits the above-described authentication information to the control device 10.

The near-field wireless communication section 210 according to the present embodiment includes an antenna to perform the near-field wireless communication described above.

((Control Section 220))

The control section 220 according to the present embodiment controls the near-field wireless communication between the near-field wireless communication section 210 and the portable device 10.

For example, the function of the control section 220 is implemented by a processor such as a CPU or an IC.

((Storage Section 230))

The storage section 230 according to the present embodiment stores various kinds of information to be used for operation of the portable device 20. For example, the storage section 230 stores the above-described authentication information. In addition, the storage section 230 stores various kinds of programs to be used by the control section 220.

The configuration example of the system 1 according to the present embodiment has been described above. Note that, the configuration described above with reference to FIG. 1 is a mere example. The configuration of the system 1 according to the present embodiment is not limited thereto. The configuration of the system 1 according to the present embodiment may be flexibly modified in accordance with specifications and operations.

### 1.2. Flow of Operation

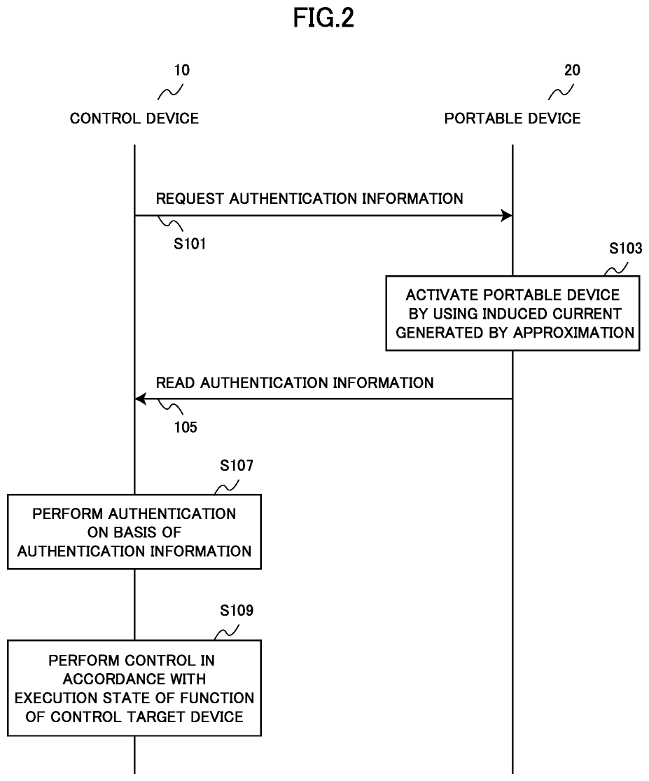

Next, a flow of operation of the system 1 according to the present embodiment will be described in detail. FIG. 2 is a sequence diagram illustrating an example of the flow of the operation of the system 1 according to the present embodiment. Note that, hereinafter, an example in which the portable device 20 according to the present embodiment is implemented by an IC card that does not include an electric power supply source such as a battery.

First, the near-field wireless communication section 110 of the control device 10 transmits a signal for requesting authentication information (S101).

Here, when the user puts the portable device 20 closer to an area within a communication range of the near-field wireless communication section 110, a magnetic field of the antenna of the near-field wireless communication section 210 of the portable device 20 is changed by a signal emitted from the near-field wireless communication section 110, and this causes an induced current. The portable device 20 according to the present embodiment may be activated by using the induced current (S103). As described above, it is possible to activate the portable device 20 according to the present embodiment even in the case where the portable device 20 is not provided with the electric power supply source.

Next, the near-field wireless communication section 110 of the control device 10 reads the authentication information from the portable device 20 activated in Step S103 (S105).

In other words, the near-field wireless communication section 110 of the control device 10 according to the present embodiment makes it possible to activate the adjacent portable device 20 by using the emitted signal and acquire an authentication signal from the portable device 20.

Next, the control section 120 of the control device 10 authenticates the mobile device 20 on the basis of the authentication signal acquired by the near-field wireless communication section 110 in Step S105 (S107).

Here, in the case where the authentication is successful, the control section 120 subsequently controls a function of the control target device in accordance with an execution state of the function (S109). The control section 120 may perform control in such a manner that the execution state becomes the second state in the case where the execution state is the first state, and the control section 120 may perform control in such a manner that the execution state becomes the first state in the case where the execution state is the second state.

### 2. Supplement

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

Note that, the series of processes performed by the devices described in this specification may be achieved by any of software, hardware, and a combination of software and hardware. A program that configures software is stored in advance in, for example, a recording medium (non-transitory medium) installed inside or outside the devices. In addition, for example, when a computer executes the programs, the programs are read into RAM and executed by a processor such as a CPU. The recording medium may be a magnetic disk, an optical disc, a magneto-optical disc, flash memory, or the like, for example. Alternatively, the above-described computer program may be distributed via a network without using the recording medium, for example.

### REFERENCE SIGNS LIST

1 system
10 control device
110 near-field wireless communication section
120 control section
130 storage section
20 portable device
210 near-field wireless communication section
220 control section
230 storage section

What is claimed is:

1. A control device that is installed in a mobile object, the control device comprising:
a near-field wireless communication section configured to perform near-field wireless communication with a portable device; and
a control section configured to authenticate the portable device on a basis of authentication information that the near-field wireless communication section has acquired from the portable device through the near-field wireless communication, and configured to perform control on a basis of a result of the authentication,
wherein the control section performs control in such a manner that a prescribed function related to a control target device installed in the same mobile object is executed in a case where the authentication is successful.

2. The control device according to claim 1,
wherein the control target device includes at least any of a lock device installed in the mobile object, an opening and closing device that opens and closes a door of the mobile object, and a power source device installed in the mobile object.

3. The control device according to claim 1,
wherein the control section controls execution of the prescribed function further on a basis of an execution state of a function of the control target device.

4. The control device according to claim 3, wherein
the execution state includes a first state and a second state,
the control section performs control in such a manner that the execution state becomes the second state in a case where the execution state is the first state, and
the control section performs control in such a manner that the execution state becomes the first state in a case where the execution state is the second state.

5. The control device according to claim 1,
wherein the near-field wireless communication section activates the adjacent portable device by using an emitted signal, and acquires the authentication signal from the portable device.

6. A non-transitory storage medium having a program stored therein, the program causing a computer to function as a control device that is installed in a mobile object,
wherein control device executes
a control function of authenticating a portable device on a basis of authentication information acquired from the portable device through near-field wireless communication, and performing control on a basis of a result of the authentication, and
the control device performs control in such a manner that a prescribed function related to a control target device installed in the same mobile object is executed in a case where the authentication is successful.

7. A system that includes a portable device and a control device installed in a mobile object,
wherein the control device includes
a near-field wireless communication section configured to perform near-field wireless communication with the portable device, and
a control section configured to authenticate the portable device on a basis of authentication information that the near-field wireless communication section has acquired from the portable device through the near-field wireless communication, and configured to perform control on a basis of a result of the authentication, and
the control section performs control in such a manner that a prescribed function related to a control target device installed in the same mobile object is executed in a case where the authentication is successful.
